(19) United States
(12) Patent Application Publication
(10) Pub. No.: US 2015/0354763 A1
(43) Pub. Date: Dec. 10, 2015

(54) Recharging Flashlight Holster

(71) Applicant: Phillip Lanier, Uvalde, TX (US)

(72) Inventor: Phillip Lanier, Uvalde, TX (US)

(73) Assignee: Phillip Lanier, Uvalde, TX (US)

(21) Appl. No.: 14/732,597

(22) Filed: Jun. 5, 2015

Related U.S. Application Data
(60) Provisional application No. 62/009,880, filed on Jun. 9, 2014.

(51) Int. Cl. F21L 4/08; H02J 7/00; F21V 33/00

(52) U.S. Cl. CPC F21L 4/085; F21V 33/0008; H02J 7/0042; H02J 7/0052; F21W 2131/30

(57) ABSTRACT

A flashlight holster, flashlight and a recharging unit that is both functional and practical. The flashlight has a rechargeable battery that does not have to be removed to be charged. The flashlight has an external connection that can recharge the battery by placing the flashlight on to a charger with out removing the battery. The holster has a power source such as a battery or multiple batteries that will be able to charge or recharge the flashlights battery or batteries whenever the flashlight is holstered. The holster's power pack and/or battery can be recharged with a separate recharging cord that can be plugged into a vehicles power outlet or any power outlet and plugged directly into the holster. The outlet recharging unit plugs into a power outlet and can simultaneously recharge both the holsters power pack and/or battery and the flashlights battery.

### RELATED APPLICATIONS

The present application is a continuation-in-part application of U.S. provisional patent application, Ser. No. 62/009,880, filed Jun. 9, 2014, for FLASHLIGHT HOLSTER, by Phillip Lanier, included by reference herein and for which benefit of the priority date is hereby claimed.

### FIELD OF THE INVENTION

The present invention relates to flashlights and flashlight holsters and, more particularly, to a flashlight holster that recharges flashlight batteries while the flashlight is holstered.

### BACKGROUND OF THE INVENTION

Ever since flashlights were invented, there has been a need to store the flashlight on the user when the flashlight is not in use for easy access while protecting the flashlight. There is also a need to recharge the flashlight's batteries so the user does not need to remove old batteries and replace them with new ones.

Flashlight holsters have been invented so the user can store their flashlight when not in use for quick and easy access. The holsters are typically mounted on a belt worn by the user. Flashlight holsters are especially used by civil servants such as police officers and fire fighters as well as military personnel. One example of a holster for a flashlight is disclosed in U.S. Pat. No. 5,593,074. Unfortunately, these solutions only resolve the need to store the flashlight on the person and does not address the power drain issue when the flashlight is in use.

Rechargeable flashlights have been invented so the user does not have to remove the batteries and replace or recharge them. Instead, they can plug the flashlight into a device which gets its charge from an electrical outlet. Such devices can be found in stores that sell flashlights as well as mail order and are described, for example, in the U.S. Pat. No. 7,389,899, U.S. Pat. No. 2,500,257, U.S. Pat. No. 7,347,583, U.S. Pat. No. 3,970,228, U.S. Pat. No. 3,005,091, U.S. Pat. No. 5,752,633, U.S. Pat. No. 4,794,315, US20130343042, U.S. Pat. No. 3,829,676, U.S. Pat. No. 8,376,568, U.S. Pat. No. 3,096,941, U.S. Pat. No. 3,825,740. These solutions resolve the issue of recharging a flashlights battery, but does not allow a user to store the flashlight on the person while the flashlight is being charged.

Prior art flashlight holsters only provide a means to store the flashlight when not in use. An individual must carry spare batteries or be near a power source such as a wall outlet. During use, the battery may loose power which will cause the flashlight to dim or not work. This can be dangerous for individuals that rely on their flashlight such as law enforcement officers, fire fighters or military personnel at a critical moment during use. Prior art rechargeable flashlights can only be recharged near a power source such as a wall outlet. An individual using the flashlight that is in a remote location or not near a wall outlet can not recharge the flashlight battery rendering the flashlight useless until they can find a means to charge it. This can pose a problem for individuals during use and can become dangerous for individuals that have a critical need for their flashlight such as law enforcement officers, fire fighters and military personnel.

### SUMMARY OF THE INVENTION

In accordance with the present invention, there is provided a recharging flashlight holster that is both functional and practical. The holster has a removable power source such as a battery or multiple batteries that will be able to charge or recharge the flashlights battery or batteries whenever the flashlight is holstered. The holster's power pack and/or battery can be recharged with a separate recharging cord that can be plugged into a vehicles power outlet or any power outlet and plugged directly into the holster. The outlet recharging unit plugs into a power outlet and can simultaneously recharge both the holsters power pack and/or battery and a flashlights battery.

It would be advantageous to provide a holster for flashlights that will charge and/or recharge a flashlights batteries when the flashlight is placed into the holster.

It would also be advantageous for the holsters power source to be removable from the holster in order for it to be replaced if necessary.

It would also be advantageous for the holsters power source to have one or multiple ports to recharge as well as to recharge other electronic devices.

It would further be advantageous for the holster and/or its power source to have a power indicator allowing the user to see the amount of power left in the power source.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a recharging flashlight holster in accordance with the invention;

FIG. 2 is a perspective view of a recharging flashlight holster with the removable power pack separated from the recharging flashlight holster; and

FIG. 3 is a top view of a recharging flashlight holster without a flashlight of FIG. 1.

For purposes of clarity and brevity, like elements and components will bear the same designations and numbering throughout the Figures.

### DESCRIPTION OF THE PREFERRED EMBODIMENT

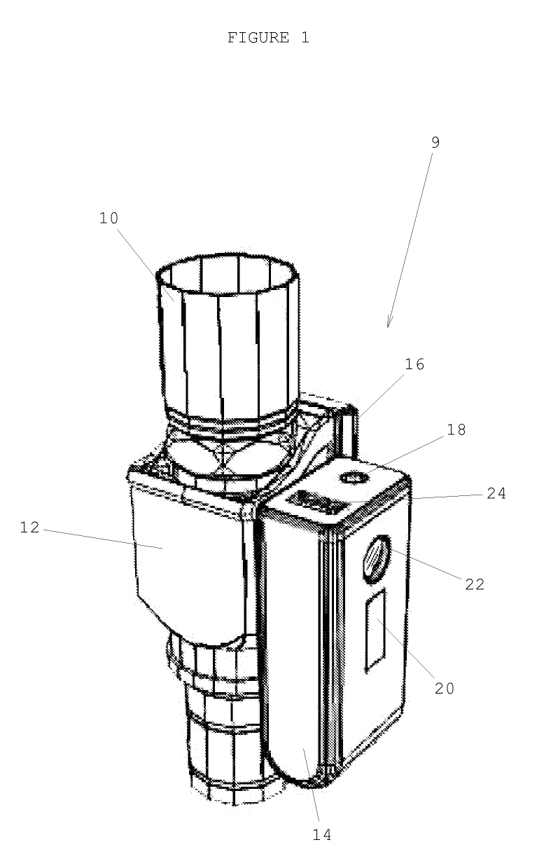

FIG. 1 is a perspective view of a recharging flashlight holster 9 in accordance with the invention. The recharging flashlight holster 9 consists of a holster which holds, stores, secures and recharges a flashlight 10 when the flashlight 10 is placed in the flashlight slot 28. The flashlight slot 28 is formed and shaped to secure, hold and store a flashlight 10. The flashlight slot 28 may have a flexible retaining object in order to aid in keeping the flashlight 10 snug with additional security. The recharging flashlight holster 9 may be made of plastic, metal or any suitable material. A removable power pack 14 provides power to recharge the flashlights battery when the flashlight 10 is securely in its holster. The recharging flashlight holster 9 has an attachment mount 16 that may be removable or fixed to the recharging flashlight holster 9. The attachment mount 16 is for attaching the recharging flashlight holster 9 system on to a belt, garment or any other article or object. The attachment mount 16 can be made of plastic, metal, nylon or any suitable material.

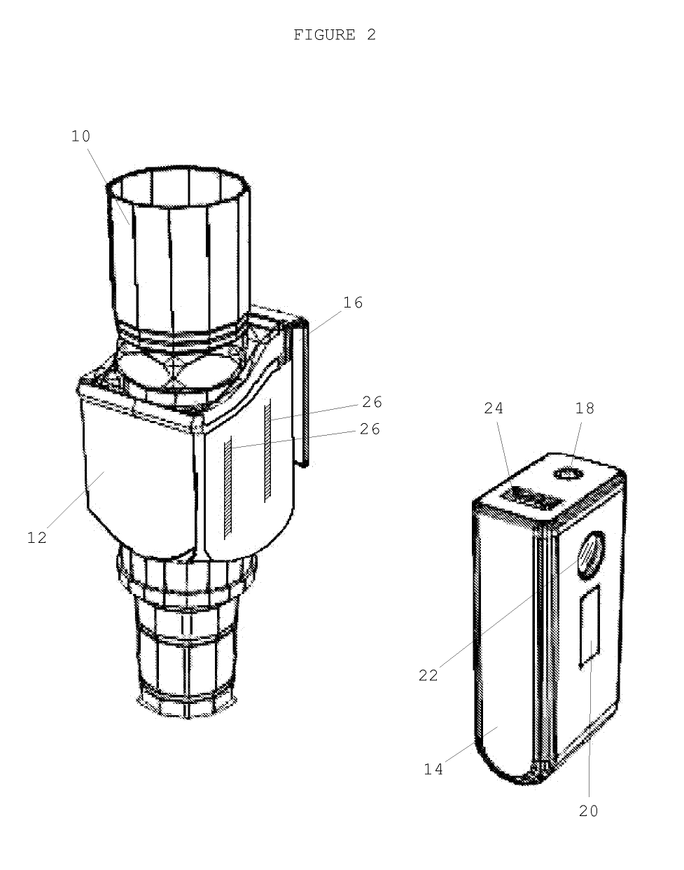

FIG. 2 is a front perspective view of a recharging flashlight holster 9 with the removable power pack 14 shown separated from the recharging flashlight holster 9. The power pack 14 supplies and stores power to recharge a flashlight 10 when ever the flashlight 10 is placed into the recharging holster 12 by completing an electrical circuit from the power pack 14's stored energy to the contact point to power pack 30, to the contact point to flashlight 32 and to the flashlight 10. The power pack 14's power may be a self contained power source, battery or may be a housing for a removable battery or batteries. The power pack 14 may also contain a flash memory for the storage and transfer of data. The power pack 14 may have a recharging port 18 for recharging the power pack 14 by means of a power cord in to its port with another power source such as a power outlet. The power pack 14 may have a charge indicator 20 that allows the user to visually see the amount of charge or power left in the power pack 14. The display of the charge indicator 20 may be shown as a bar, numeric, iconic or any suitable means. A power button 22 may activate the display of the charge indicator 20 when the user activates it. The power pack 14 may have an external port 24 such as a universal serial bus port that allows other electronic devices to be connected and charged or powered by the power pack 14 as well as transfer data to and from the power pack 14.

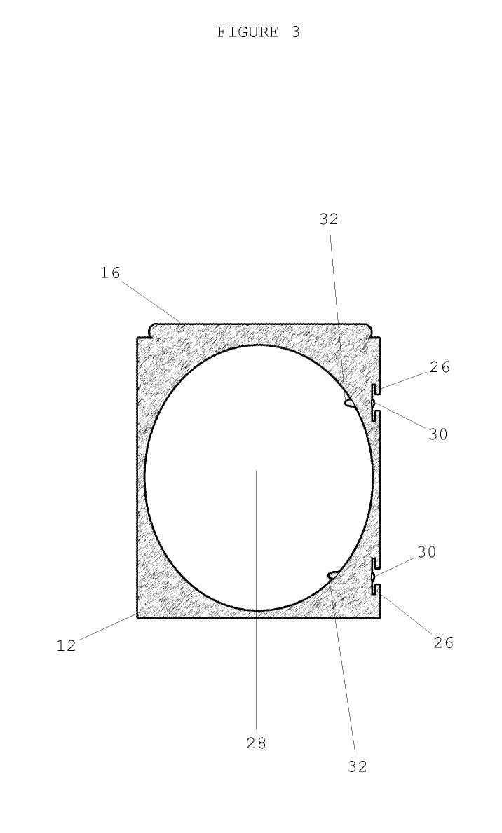

FIG. 3 is a top view of the recharging flashlight holster 9 without a flashlight 10 of FIG. 1 and shown without the power pack 14 attached to it. The recharging holster 12 contains a connector 26 which connects the power pack 14 to the recharging holster 12 that may be easily attached or removed at the users convenience. The recharging holster 12 contains a contact point to power pack 30 in which it completes a circuit from the power pack 14 to the contact point to flashlight 32 and to the flashlight 10 when holstered.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A recharging flashlight holster for holstering, securing and recharging a rechargeable flashlight when the flashlight is in the holster, comprising:
means for holding, securing and storing a flashlight which completes a circuit from the power pack to the flashlight for recharging a flashlight;
means for supplying power to recharge the flashlights battery when the flashlight is secured in its holster;
means for attaching the recharging flashlight holster on to a belt, garment or any other article or object, firmly connected to said means for holding, securing and storing a flashlight which completes a circuit from the power pack to the flashlight for recharging a flashlight;
means for completing an electrical circuit from the power pack through the holster to the flashlight, detachably connected to said means for supplying power to recharge the flashlights battery when the flashlight is secured in its holster, and securely connected to said means for holding, securing and storing a flashlight which completes a circuit from the power pack to the flashlight for recharging a flashlight; and
means for completing an electrical circuit to recharge the flashlights battery, electrically connected to said means for completing an electrical circuit from the power pack through the holster to the flashlight.

2. The recharging flashlight holster in accordance with claim 1, wherein said means for holding, securing and storing a flashlight which completes a circuit from the power pack to the flashlight for recharging a flashlight comprises a recharging holster.

3. The recharging flashlight holster in accordance with claim 1, wherein said means for supplying power to recharge the flashlights battery when the flashlight is secured in its holster comprises a detachable power pack.

4. The recharging flashlight holster in accordance with claim 1, wherein said means for attaching the recharging flashlight holster on to a belt, garment or any other article or object comprises an attachment mount.

5. The recharging flashlight holster in accordance with claim 1, wherein said means for completing an electrical circuit from the power pack through the holster to the flashlight comprises a contact point to power pack.

6. The recharging flashlight holster in accordance with claim 1, wherein said means for completing an electrical circuit to recharge the flashlights battery comprises a contact point to flashlight.

7. A recharging flashlight holster for holstering, securing and recharging a rechargeable flashlight when the flashlight is in the holster, comprising:
a recharging holster, for holding, securing and storing a flashlight which completes a circuit from the power pack to the flashlight for recharging a flashlight;
a detachable power pack, for supplying power to recharge the flashlights battery when the flashlight is secured in its holster;
an attachment mount, for attaching the recharging flashlight holster on to a belt, garment or any other article or object, firmly connected to said recharging holster;
a contact point to power pack, for completing an electrical circuit from the power pack through the holster to the flashlight, detachably connected to said power pack, and securely connected to said recharging holster; and
a contact point to flashlight, for completing an electrical circuit to recharge the flashlights battery, electrically connected to said contact point to power pack.

8. The recharging flashlight holster as recited in claim 7, further comprising:
a recharging port, for recharging the holsters battery supply by means of a power cord in to its port with another power source such as a power outlet, electrically interconnected to said power pack.

9. The recharging flashlight holster as recited in claim 7, further comprising:
a charge indicator, for visual indication of the power sources amount of charge or power left in the power pack.

10. The recharging flashlight holster as recited in claim 7, further comprising:
a power button, for turning on and off the charge indicator display screen, structurally wired to said charge indicator, and structurally wired to said power pack.

11. The recharging flashlight holster as recited in claim 7, further comprising:
an external port, for charging or powering other devices using the power sources stored energy, electrically wired to said power pack.

12. The recharging flashlight holster as recited in claim 7, further comprising:
a connector, for connecting and holding the power pack to the recharging holster, securely connected to said recharging holster, detachably attached to said power pack, and simultaneously connected to said contact point to power pack.

13. The recharging flashlight holster as recited in claim 8, further comprising:
a charge indicator, for visual indication of the power sources amount of charge or power left in the power pack, structurally wired to said power button.

14. The recharging flashlight holster as recited in claim 8, further comprising:
a connector, for connecting and holding the power pack to the recharging holster, securely connected to said recharging holster, detachably attached to said power pack, and simultaneously connected to said contact point to power pack.

15. The recharging flashlight holster as recited in claim 9, further comprising:
a power button, for turning on and off the charge indicator display screen, structurally wired to said charge indicator, and structurally wired to said power pack.

16. The recharging flashlight holster as recited in claim 9, further comprising:
an external port, for charging or powering other devices using the power sources stored energy, electrically wired to said power pack.

17. The recharging flashlight holster as recited in claim 7, wherein said power pack has characteristics selected from the following group: may be a self contained power source or battery, may be a housing for a battery or batteries, may contain a flash memory, and transfer and/or store data.

18. A recharging flashlight holster for holstering, securing and recharging a rechargeable flashlight when the flashlight is in the holster, comprising:
a plastic, round, square, oval, rectangular recharging holster, for holding, securing and storing a flashlight which completes a circuit from the power pack to the flashlight for recharging a flashlight;
a detachable, may be a self contained power source or battery, may be a housing for a battery or batteries, may contain a flash memory, transfer and/or store data power pack, for supplying power to recharge the flashlights battery when the flashlight is secured in its holster;
a metal, plastic, clip on, removable, fixed attachment mount, for attaching the recharging flashlight holster on to a belt, garment or any other article or object, firmly connected to said recharging holster;
a recharging port, for recharging the holsters battery supply by means of a power cord in to its port with another power source such as a power outlet, electrically interconnected to said power pack;
a charge indicator, for visual indication of the power sources amount of charge or power left in the power pack;
a push button, toggle switch power button, for turning on and off the charge indicator display screen, structurally wired to said charge indicator, and structurally wired to said power pack;
an universal serial bus port, transfer and/or store data external port, for charging or powering other devices using the power sources stored energy, electrically wired to said power pack;
a metal, plastic, slotted, notched connector, for connecting and holding the power pack to the recharging holster, detachably attached to said power pack, and securely connected to said recharging holster;
a contact point to power pack, for completing an electrical circuit from the power pack through the holster to the flashlight, simultaneously connected to said connector, detachably connected to said power pack, and securely connected to said recharging holster; and
a contact point to flashlight, for completing an electrical circuit to recharge the flashlights battery, electrically connected to said contact point to power pack.
